(19) United States
(12) Patent Application Publication
(10) Pub. No.: US 2025/0337509 A1
(43) Pub. Date: Oct. 30, 2025

(54) PREDICTING CELLULAR CIRCUIT BANDWIDTH BASED ON PREDICTED CHANNEL CONDITIONS

(71) Applicant: Palo Alto Networks, Inc., Santa Clara, CA (US)

(72) Inventors: Madhusudana Rao Kata, Pleasanton, CA (US); Jeslin Antony Puthenparambil, Santa Clara, CA (US); Srushti Gowdru Shivakumara, Bengaluru (IN)

(21) Appl. No.: 18/651,386

(22) Filed: Apr. 30, 2024

(51) Int. Cl. H04B 17/373; H04W 24/06

(52) U.S. Cl. CPC H04B 17/373; H04W 24/06

(57) ABSTRACT

A system generates reliable bandwidth predictions which account for the dynamic behavior of cellular circuits. The system performs ongoing data collection of cellular parameters indicative of channel conditions of cellular circuits, cellular circuit performance and/or usage, bandwidth measurements of network paths that include the cellular circuits, and locations of edge devices with interfaces with cellular circuits attached. The collected data is stored as time series data to allow for repeating patterns to be detected and/or accounted. When a bandwidth prediction is triggered for a cellular circuit, the system retrieves most recent and historical data corresponding to cyclical/seasonal behavior and runs a trained model to generate a value representing likely current channel conditions of the cellular circuit. The system then uses the predicted current channel conditions value that accounts for repeating usage/performance patterns to calculate an estimated/predicted bandwidth of the cellular circuit.

### BACKGROUND

The disclosure generally relates to electronic communication techniques (e.g., CPC class H04) and arrangements for maintenance of administration of packet switching networks (e.g., CPC subclass H04L 41/00).

The terms wide area network (WAN) and local area network (LAN) identify communications networks of different geographic scope. For a LAN, the geographic area can range from a residence or office to a university campus. For a WAN, the geographic area can be defined with respect to a LAN—greater than the area of a LAN. In the context of telecommunications, a circuit refers to a discrete path that carries a signal through a network between two remote locations. A circuit through a WAN can be a physical circuit or a virtual/logical circuit. A physical WAN circuit refers to a fixed, physical path through a network. A dedicated or leased line arrangement uses a physical WAN circuit. A logical WAN circuit refers to a path between endpoints that appears fixed but is one of multiple paths through the WAN that can be arranged. A logical circuit is typically implemented according to a datalink and/or network layer protocol, although a transport layer protocol (e.g., transmission control protocol (TCP)) can support a logical circuit.

Cloud computing technologies have allowed organizations to move away from creating enterprise networks with a costly hub-and-spoke wide area network (WAN) topology, centralized servers, and lines connecting remote offices. With the adoption of cloud technologies (e.g., software-as-a-service (SaaS) applications and virtual private networks (VPNs)), organizations employed firewalls in branch offices for security and traffic optimization. To address the overlapping in technologies from the increased adoption of cloud technologies and reduced reliance on on-premise technologies, secure access service edge (SASE) has emerged as an architecture that combines networking and security as a service.

Technologies to provide this service capability include software-defined wide area network (SD-WAN) technology, secure web gateway (SWG) technology, cloud access security broker (CASB) solution, next generation firewall (NGFW) technology, firewall-as-a-service (FWaaS), and zero trust network access (ZTNA) technologies. SASE supports the variety of use cases that organizations must support securely: branch office, remote worker, and on-premises. The SASE architecture enables an organization to support dispersed remote and hybrid users by connecting them to nearby cloud gateways instead of backhauling traffic to corporate data centers. A SASE solution/architecture also provides consistent secure access to applications while maintaining visibility and inspection of traffic across ports and protocols.

### BRIEF DESCRIPTION OF THE DRAWINGS

Embodiments of the disclosure may be better understood by referencing the accompanying drawings.

FIG. 1 is a conceptual diagram of a system that generates cellular circuit bandwidth predictions for a tenant WAN.

FIG. 2 is a flowchart of example operations for collecting data for bandwidth prediction for a cellular WAN.

FIG. 3 is a flowchart of example operations for predicting bandwidth of an enterprise WAN cellular circuit.

FIG. 4 is a flowchart of example operations for training a model to predict a current channel conditions weighting factor for a cellular circuit.

FIG. 5 depicts an example computer system with an enterprise WAN cellular circuit bandwidth predictor.

### DESCRIPTION

The description that follows includes example systems, methods, techniques, and program flows to aid in understanding the disclosure and not to limit claim scope. The description refers to bandwidth of a cellular circuit. However, the bandwidth of a cellular circuit can differ between the uplink and the downlink. Since the bulk of operations are the same between uplink and downlink bandwidth prediction, the distinction is eschewed for most of the description. Well-known instruction instances, protocols, structures, and techniques have not been shown in detail for conciseness.

### Terminology

The term “cellular circuit” refers to the circuit between a cellular modem integrated into an edge device and a base station. A cellular circuit consists of an uplink and a downlink. The majority of the description refers to the cellular circuit without distinguishing between the uplink and downlink.

The description uses bandwidth and throughput, which are often used inconsistently in literature. Bandwidth refers to the capacity or maximum possible data transfer rate of a link for a given time interval. Throughput refers to actual data transfer rate for a given time interval. Both the bandwidth and the throughput of the uplink and the downlink can differ. However, the description refers to the bandwidth and throughput of a cellular circuit to simplify explanation of the technology and avoid the inefficiency of repeatedly differentiating between the uplink bandwidth and throughput and the downlink bandwidth and throughput.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### INTRODUCTION

A SASE architecture includes one or more SD-WAN controllers and branch office edge devices of an enterprise. The SD-WAN controller(s) facilitates network management, which includes communicating per tenant policies to the branch office edge devices. To connect the tenant network to its disparate local networks and the Internet, a tenant will employ circuits of different types. For example, a local network of a branch site may connect to the tenant network with circuits of a cellular network and cable network. The edge devices at the branch site will have multiple interfaces that are configured for the different circuits. The edge devices receive policies from a SD-WAN controller(s) of a tenant and make path selections to comply with the policies, such as quality of service (QOS) parameters defined in the policy. The data transfer rate set for a circuit (“circuit bandwidth”) impacts path selection. For instance, a QoS parameter may specify percentages of circuit bandwidth to allocate to different types of application traffic and/or traffic priority levels.

Organizations rely on redundancy and diversity in connectivity for stability in connectivity. Thus, organizations may use cellular circuits for network connectivity. However, this shared media and technology presents challenges for accurate path selection. In addition to variability introduced from a cellular circuit being a shared media, performance of a cellular circuit is affected by uncontrolled radio phenomena. Complex spatiotemporal characteristics of radio can degrade circuit performance. These challenges have led to manual setting of upload and download cellular circuit bandwidths. The manual settings will typically rely on the maximum potential/possible bandwidth specified for a cellular circuit, for instance indicated in a service legal agreement or data plan by a cellular network operator/carrier. Informing path selection with the maximum possible bandwidth is problematic at least because it is not guaranteed at least for the aforementioned characteristics of a cellular circuit. The likely variance from this maximum circuit bandwidth can lead to sub-optimal path selection which can interfere with policy compliance.

### Overview

A system has been developed that generates reliable bandwidth predictions which account for the dynamic behavior of cellular circuits. These reliable bandwidth predictions facilitate support of QoS in a SASE architecture with cellular circuits and avoids the degrading impact from using an inaccurate, manually configured circuit bandwidth. The system performs ongoing data collection of cellular parameters indicative of channel conditions of cellular circuits, cellular circuit performance and/or usage, bandwidth measurements of network paths that include the cellular circuits, and locations of edge devices with interfaces with cellular circuits attached. The collected data is stored as time series data to allow for repeating patterns to be detected and/or accounted. When a bandwidth prediction is triggered for a cellular circuit, the system retrieves most recent and historical data corresponding to cyclical/seasonal behavior and runs a trained model to generate a value representing likely current channel conditions of the cellular circuit. The trained model predicts the current channel conditions value based on multiple observations: a time/temporal attribute of a repeating usage/performance pattern, a value representing most recently observed channel conditions for the cellular circuit, most recently reported location of the edge device corresponding to the cellular circuit, a historical value representing historical channel conditions of the cellular circuit based on the time attribute, and historical performance/usage data of the cellular circuit based on the time attribute. The trained model has been trained to predict how the impact of seasonal or cyclical behavior impacts these values representing most recent observations, as the time of the most recent observations may not align with the cycle or season. The system then uses the predicted current channel conditions that accounts for repeating usage/performance patterns to calculate an estimated/predicted bandwidth of the cellular circuit. The calculation modifies a most recent bandwidth measurement with an aggregation of the predicted current channel conditions value and weighting factors corresponding to the cyclical or seasonal usage/performance behavior.

### Example Illustrations

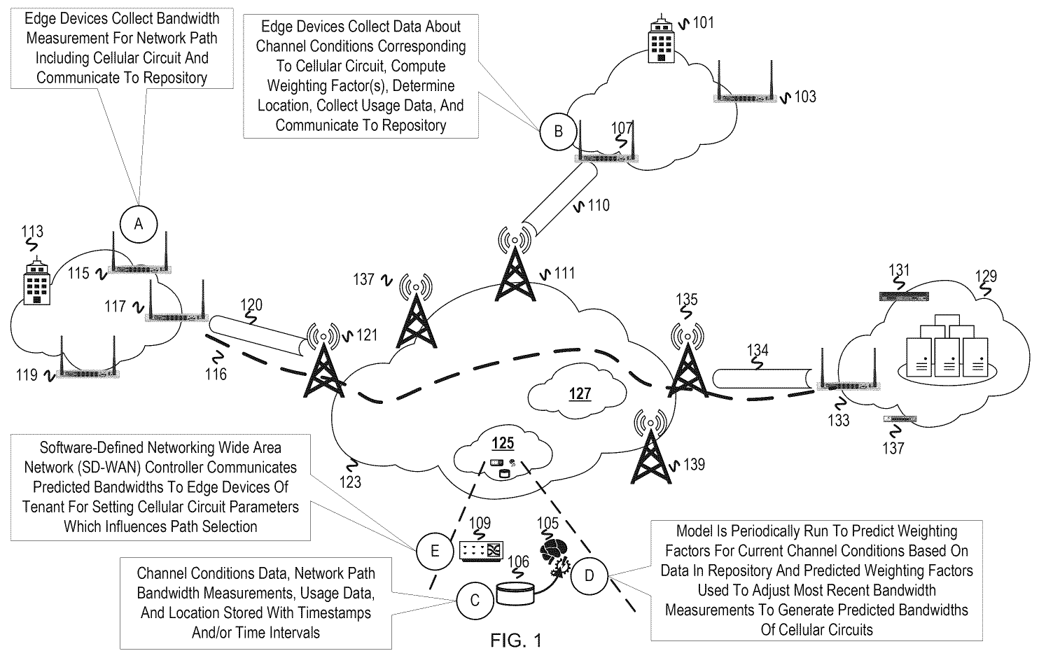

FIG. 1 is a conceptual diagram of a system that generates cellular circuit bandwidth predictions for a tenant WAN. The system includes edge devices and a cloud-hosted service 125 in this illustration. While on-premise or hybrid deployments are possible for this technology, this example illustration refers to the cloud-hosted service 125. The cloud-hosted service 125 offers the tenant a SD-WAN controller 109, access to a trained model 105, and a repository 106 (e.g., data lake or data warehouse). FIG. 1 depicts another cloud-hosted service 127 as one instance of the possible variety of connections possible. This example illustration refers to a tenant since an enterprise can have multiple departments with at least one of the departments using multiple tenant WANs, and policies would typically be applied at tenant granularity.

The illustrated example tenant WAN includes a branch site 101, a branch site 113, and a data center 129. The branch site 101 includes edge devices 103, 107. The network of the branch site 101 is illustrated as having connectivity via a cellular circuit 110 to a base station 111. The branch site 113 includes edge devices 115, 117, 119. The network of the branch site 113 is illustrated as having connectivity via a cellular circuit 120 to a base station 121. The data center 129 includes edge devices 131, 133, 137. The network of the data center 129 is illustrated as having connectivity via a cellular circuit 134 to a base station 135. Each of the local networks for the branch sites 101, 113 and the data center 129 is depicted as having connectivity via a single cellular circuit for simplicity of the diagram. Each local network can have connectivity via other types of circuits. The edge devices 103, 107, 115, 117, 119, 133 are edge devices with modems for cellular communication capability. Each of the cellular circuits 110, 120, 134 can be attached to interfaces of multiple edge devices. In addition, each of the local networks can have multiple cellular circuits of multiple carriers providing connectivity. The data center 129 is depicted with different types of edge devices. This can also be the case for the branch sites 101, 113, but is not necessary to depict for describing the technology. An example of a typical enterprise or tenant WAN has 20-30 edge devices at each of 3-4 sites. In addition to the base stations 111, 121, 135, FIG. 1 depicts base stations 137, 139, all providing connectivity to public network 123. The additional base stations 137, 139 are depicted to represent the possibility of cellular circuits switching base stations.

FIG. 1 is annotated with a series of letters A-D, each of which represents one or more operations. These stages of operations present operations at a high level as an introduction to the technology and should not be construed as strict ordering, especially for the claimed subject matter. Stages representing multiple operations likely represent asynchronous operations, such as the data gathering by multiple edge devices across different sites of a tenant. In addition, the operations recur and are performed by different actors.

At stage A, edge devices obtain bandwidth measurements for network paths that include cellular circuits and communicate the bandwidth measurements to the repository 106. For instance, the edge device 117 measures bandwidth of a network path 116 that includes the cellular circuit 120. FIG. 1 depicts the network path 116 as being from the edge device 117 to the data center 129. The path 116 traverses public network 123. Although the network path 116 is depicted in a manner that suggests it also traverses the cellular circuit 134 to the data center 129, this is not necessary. Each of the edge devices 103, 107, 115, 119, 133, 117, runs a tool or application to obtain the bandwidth measurement according to a configured schedule. Since these network path bandwidth measurements incur the expense of using capacity of the cellular circuits, a customer or tenant likely configures the edge devices to obtain the bandwidth measurements infrequently, at least with respect to the gathering of data to be described with respect to stage B. Each of the bandwidth measurements is associated with the time of the measurement and an identifier that identifies the edge device and interface corresponding to the measurement.

At stage B, the edge devices 103, 107, 115, 117, 119, 133 collect data about channel conditions corresponding to cellular circuits attached to their interfaces. The data includes values of radio parameters (e.g., type of radio technology, frequency, frequency bandwidth) and signal parameters indicative of quality, strength, and stability. Signal parameters can include signal-to-noise ratio (SNR), radio signal strength indicator (RSSI), reference signals received power (RRSP), reference signals received quality (RSRQ), and channel quality indicator or index (CQI). The edge devices 103, 107, 115, 117, 119, 133 also collect network traffic statistics (e.g., packets dropped and errors) which are also relevant to channel conditions. The data is aggregated into a weighting factor that represents channel conditions of the corresponding cellular circuit at the time of the collection or observations. The edge devices 103, 107, 115, 117, 119, 133 determine and report location (e.g., coordinates) since the placement of the edge devices can influence channel conditions. The edge devices 103, 107, 115, 117, 119, 133 also collect usage data (e.g., throughput) which can indicate repetitive behavior that impacts bandwidth. The collected data and channel conditions weighting factor are communicated for storage into the repository 106.

At stage C, the service 125 stores into the repository 106 the data communicated from the edge devices 103, 107, 115, 117, 119, 133. The service 125 stores the channel conditions data and/or channel conditions weighting factors, usage data, and location with their timestamps and/or time intervals. The data is organized in the repository 106 by reporting edge device and relevant interface (e.g., an identifier or combination of identifiers of the edge device and interface).

At stage D, the model 105 is periodically run to predict weighting factors for current channel conditions based on data in the repository 106. In this illustration, the SD-WAN controller 109 runs the model 105 either in response to a cellular circuit event (e.g., attachment of a cellular circuit to an interface) or on a schedule in the background (e.g., every 10 minutes). The controller 109 runs the model 105 for each interface of the tenant WAN with an attached cellular circuit. For a cellular circuit, the model 105 generates a predicted/estimated weighting factor that represents “current” channel conditions of the cellular circuit. The model 105 generates the predicted weighting factor based on a most recent channel conditions weighting factor and data relevant to channel conditions and cyclical/seasonal usage behavior. This will be explained in more detail with reference to the flowcharts. The SD-WAN controller 109 uses the predicted weighting factor to calculate a predicted bandwidth for the cellular circuit. The calculation modifies or adjusts a most recent network path bandwidth measurement corresponding to the cellular circuit with the predicted weighting factor to account for current channel conditions and other weighting factors that represent repeating usage patterns relevant to the cellular circuit. This will also be explained in more detail with reference to the flowcharts.

At stage E, the SD-WAN controller 109 communicates the predicted bandwidths to edge devices of the tenant WAN. The predicted bandwidths are used to configure/set cellular circuit parameters, which influence the path selection by the edge devices and policy compliance.

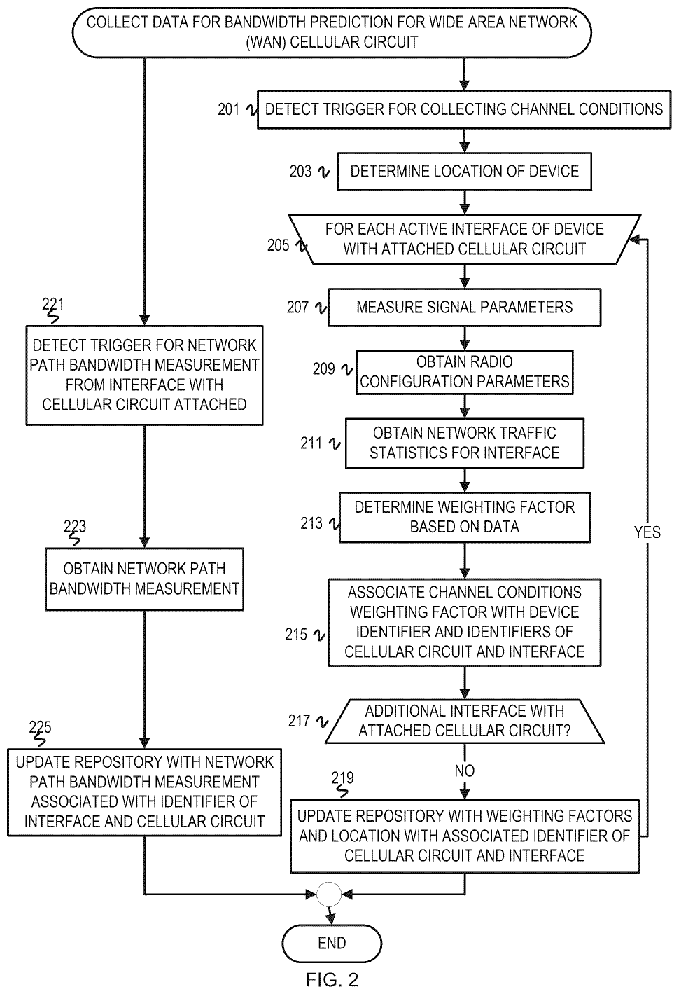

FIG. 1 provides an example for the disclosed bandwidth prediction, describing with collective references the edge devices of a tenant WAN. The flowcharts describe example operations at cellular circuit granularity. FIG. 2 is a flowchart of example operations for collecting data for bandwidth prediction for a cellular WAN. The example operations are described with reference to an edge device as performing the operations. FIG. 2 presents two paths of operations for the edge device to collect the data: one path to collect data of channel conditions for the cellular circuit starting at block 201 and another path to collect a network path bandwidth measurement starting at block 221. Each path of operations recurs according to different configured schedules. The path of operations to collect the channel conditions data are likely configured to repeat more frequently than the path of operations to obtain network path bandwidth measurements.

At block 201, the edge device detects a trigger for collecting channel conditions data. The edge device will have been configured with one or more triggers to collect the channel conditions data. An example temporal trigger is expiration of a defined interval. Example event triggers include hardware interruption events and movement.

At block 203, the edge device determines location of the device. The edge device can use a network address assigned to an interface of the edge device that has the cellular circuit attached to determine location of the edge device. If available, the edge device can use a global positioning system (GPS)/global navigation satellite system (GNSS) receiver to determine location.

At block 205, the edge device iteratively performs operations to collect data about observations related to channel conditions. The operations are performed for each active interface of the edge device that has an attached cellular circuit. These operations correspond to blocks 207, 209, 211, 213, and 215.

At block 207, the edge device measures signal parameters. As mentioned with reference to FIG. 1, signal parameters are indicative of signal strength, signal quality, and signal stability. Each of the signal parameters SNR, RSSI, RRSP, RSRQ, and CQI provides a different data point relevant to channel conditions for the cellular circuit. Embodiments do not necessarily measure all of the signal parameters. For instance, embodiments may only obtain measurements for SNR, RSSI, and RSRQ.

At block 209, the edge device obtains radio configuration parameters. For instance, the edge device reads configuration data of the cellular modem. Examples of the radio configuration parameters includes radio technology (e.g., 3G, 4G, 5G), radio frequency band (e.g., b3, b4, b5), and frequency bandwidth (e.g., 20 megahertz (Mhz), 100 Mhz).

At block 211, the edge device obtains network traffic statistics for the interface. The edge device maintains the traffic statistics, such as packet loss, for a defined interval at each interface. For the channel conditions data, the edge device may derive a statistic (e.g., 20% packet loss) instead of the raw count of dropped packets.

At block 213, the edge device determines a weighting factor based on the collected data. The weighting factor is a value representative of the channel conditions of the cellular circuit at the time. The weighting factor is one component in the calculation for modifying/adjusting a bandwidth measurement to account at least for channel conditions. Implementations for determining this representative value can vary significantly without departing from the scope of the claimed technology. To illustrate, each of the parameters that contribute to channel conditions can be assigned a weighting factor. The edge device can aggregate these individual parameter-based weighting factors into the channel conditions weighting factor. The implementation can assign weighting factors depending upon a specific value of a parameter or where a value falls within defined sub-ranges of a parameter. These individual parameter weighting factors can be constants/hard-coded and/or be configurable variables. The tables below provide an example of configurable weighting factors and hard-coded weighting factors.

TABLE 1
Radio Technology Weighting Factors

| Radio Technology | weight_factor_t |
|---|---|
| 3G | 0.9 |
| 4G | 1.0 |
| 5G | 1.1 |

TABLE 2
Radio Frequency Band Weighting Factors

| Frequency Band | weight_factor_b |
|---|---|
| low band | weight_factor_low |
| mid band | weight_factor_mid |
| high band | weight_factor_high |

TABLE 3
Radio Frequency Bandwidth Weighting Factors

| | |
|---|---|
| Frequency Bandwidth | weight_factor_bw |

| | | |
|---|---|---|
| <=20 | Mhz | weight_factor_20 |
| <=50 | Mhz | weight_factor_50 |
| <=100 | Mhz | weight_factor_100 |
| >100 | Mhz | weight_factor_100plus |

TABLE 4
Signal Strength/Quality Weighting Factors

| Signal Information | weight_factor_s |
|---|---|
| Excellent | weight_factor_excellent |
| Good | weight_factor_good |
| Poor | weight_factor_poor |
| Dead-zone | weight_factor_deadzone |

TABLE 5
Network Traffic Statistics Weighting Factors

| Packet Statistics | weight_factor_ps |
|---|---|
| Zero drops | weight_factor_drop0 |
| <20% | weight_factor_drop20 |
| <50% | weight_factor_drop50 |
| >50% | weight_factor_drop50plus |

An aggregation of the weighting factors to determine the channel conditions weighting factor (cc_wf) can be an average of the weighting factors:

cc_wf=average (weight_factor_t, weight_factor_b, weight_factor_bw, weight_factor_s, weight_factor_ps). The weighting factors in Table 1 are hard-coded while the other tables map parameter values to variables for weighting factors. Table 1 maps specific parameter values to weighting factors, while Table 3 and 5 assign ranges of values to weighting factors. Implementations can vary with bounding the weighting factors. For example, the weighting factors can be set with respect to a 0 to 2 scale, representing scale of modification of a bandwidth measurement in a range from 0 to double. The scale of weighting factors can also vary by device. For instance, the weighting factors for a device that supports up to 400 Mbps for download and 150 Mbps for upload can be set to a smaller scale than a device that supports 1 Gbps for download and 300 Mbps for upload. As another example, the weighting factors

At block 215, the edge device associates the determined channel conditions weighting factor with identifiers of the edge device, interface, and cellular circuit. The cellular circuit and the interface each have identifiers that may be reused across devices. Thus, the channel conditions weighting factor is associated with a combination of the identifiers (e.g., concatenation of the identifiers).

At block 217, the edge device determines whether there is an additional interface with an attached cellular circuit. If there is an additional interface with an attached cellular circuit, then operational flow returns to block 205. If not, then operational flow proceeds to block 219.

At block 219, the edge device updates a repository with the channel conditions weighting factor(s) and locations of the corresponding devices. The edge device provides the channel conditions weighting factor(s) and location in association with the combined identifiers.

For the second path of operations, the edge device detects a trigger for network path bandwidth measurement at block 221. Similar to the first path, this trigger can be event or schedule driven. In addition, the schedule for bandwidth measurement can be driven by a random timer to ease load. As the bandwidth measurement is for a network path that includes a cellular circuit, the measurement is run on the interface to which the cellular circuit is attached.

At block 223, the edge device obtains a network path bandwidth measurement for the path starting at the interface with the cellular circuit attached. Since a device can have multiple interfaces, a measuring tool or application can be configured to test each of the interfaces in response to the trigger to a specified destination.

At block 225, the edge device updates the repository with the network path band measurement. As with the channel conditions and location data, the edge device communicates the network path bandwidth measurement in association with the combined identifiers for the cellular circuit, device, and interface. The network path bandwidth measurement is also associated with the time of measurement.

As mentioned previously, the operations refer to a cellular circuit without differentiating between the uplink and downlink of a cellular circuit. However, embodiments likely maintain different weighting factors for the uplink and the downlink. A cellular carrier may manage the uplink and downlink of a cellular circuit differently, usually providing more capacity for the downlink. A tenant may configure the downlink differently, for example aggregating more frequency blocks into a greater total frequency bandwidth for the downlink than the uplink. These configurations will impact the channel conditions, and thus the weighting factors, of the uplink and downlink differently. However, some information may be shared, such as the measurements of signal parameters. Thus, blocks 209 and 211 may be performed for the uplink and separately for the downlink. Accordingly, weighting factors for the uplink and downlink would be determined and not a single weighting factor. Likewise, the network path bandwidth measurement at block 223 would be performed for the uplink and performed with the downlink.

The collected data stored in the repository is associated with times to form time series data that allows for correlation with times of repeating usage patterns. Repeating usage patterns can be detected in the usage data that is collected for the tenant. Collection of the usage data is not depicted in FIG. 2 since the tenant likely already collects usage data for other reasons. However, implementation can integrate the usage data collection into this data collection. FIG. 2 can include an operation in the first path, the second path, or a separate path of operations to collect usage data. Usage data can be at interface level or device level. Implementations can aggregate the usage data for a site for site level usage data to facilitate different perspectives and determine usage patterns with different level dependent behavior.

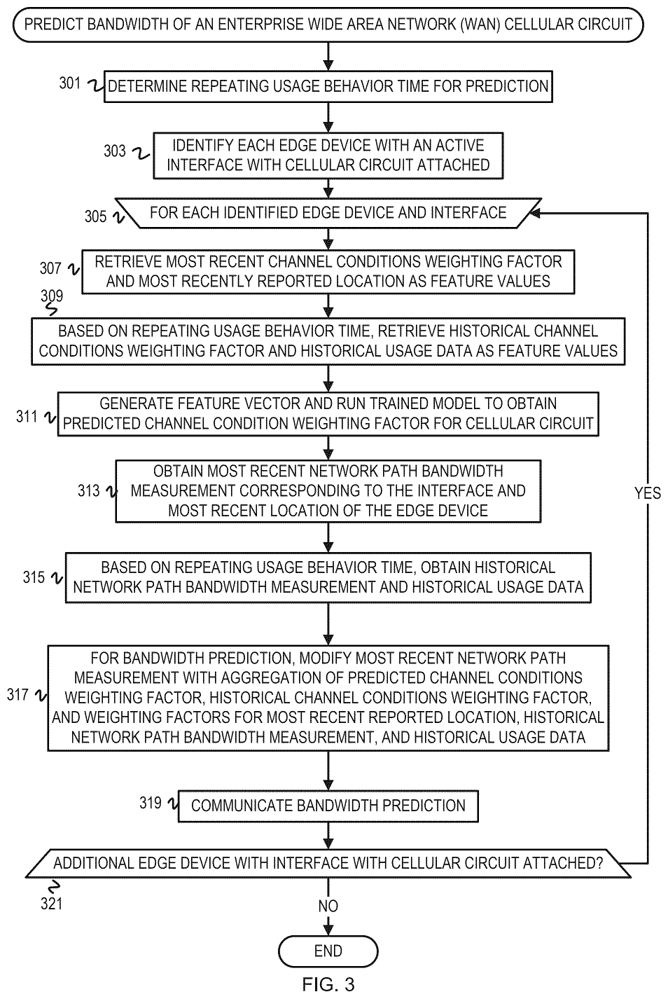

FIG. 3 is a flowchart of example operations for predicting bandwidth of an enterprise WAN cellular circuit. The example operations of FIG. 3 are described as performed by a controller (i.e., SD-WAN controller) for consistency with FIG. 1. While various deployments are possible, the example operations presume that the controller accesses the model and repository via application programming interfaces (APIs) of the model and repository. The example operations are run according to a schedule. Similar to FIG. 2, the operations of FIG. 3 are described for the cellular circuit for ease of explanation instead of specifying operations for uplink and downlink since the majority are common across links. However, bandwidth prediction is performed for the uplink and downlink of a cellular circuit. Different bandwidth predictions will be computed based on the uplink and downlink having different network traffic statistics and different channel conditions weighting factors.

At block 301, the controller determines a repeating usage behavior time for a bandwidth prediction. Scale of a repeating usage behavior time can vary, such as hours, days, or months. Moreover, a repeating usage behavior time can be an irregular interval. For example, a usage behavior (e.g., heavy streaming data usage for online meetings) may repeat on Monday from 8 am to 5 μm and on Thursday from 10 am to 3 pm. Usage behavior corresponding to background processes for backups or security scans can occur on irregular schedules that avoid primary business hours. The controller determines a repeating usage behavior time based on the current time of the prediction. Implementations can configure the controller the controller to use a different shifted time for the bandwidth prediction, perhaps taking into account time to generate the bandwidth prediction. For instance, the prediction time can be shifted forward a few minutes. To illustrate, assume a current time is used and the current time is 20240420 21:00:15 Coordinated Universal Time (UTC). A dataset of the times determined for repeating patterns can be maintained in a data structure or database. A repeating pattern time can be day of the week and month, a range of hours, etc. The controller or a pre-processing function associated with the data structure/database extracts components of the current time. In this case, the controller extracts April, Saturday, and 21:00. If any of these has a partial match with an entry in the repeating pattern time dataset, the complete match is used to be a constraint for retrieving historical data for the prediction. As an example, Saturday and 21:00:15 match an entry indicating a repeating pattern recurs on Saturdays from 20:00:00 to 23:00:00. Therefore, the controller determines the repeating usage behavior time to be Saturday and the time interval 21:00:00 to 23:00:00.

At block 303, the controller identifies each edge device with an interface with a cellular circuit attached. This presumes that the controller will run the bandwidth prediction for all active interfaces with a cellular circuit attached. Implementations can instead divide this task, for instance running bandwidth prediction for each site on a different schedule. If bandwidth prediction is run in response to an event trigger, then the bandwidth prediction would likely be run for interfaces and cellular circuits associated with the event trigger.

At block 305, the controller iteratively processes each identified device and active interface with an attached cellular circuit. Although the example operations iterate by device and interface, implementations can instead iteratively process by cellular circuit since a cellular circuit can be attached to different interfaces of different devices.

At block 307, the controller retrieves the most recent channel conditions weighting factor and most recently reported device location. The most recent channel conditions weighting factor and most recent location will be used as feature values when a feature vector is generated for predicting a current channel conditions weighting factor.

At block 309, the controller retrieves a historical channel conditions weighting factor and historical usage data based on the repeating usage behavior time. Continuing with above example of a repeating usage behavior time, the controller retrieves a channel conditions weighting factor for a Saturday within the time interval of 21:00:00-23:00:00 and preceding the most recent channel conditions weighting factor. While the same constraint can be used to retrieve a throughput with a timestamp satisfying the temporal constraint, a possibly more robust throughput dataset may allow for calculating a historical usage data according to the repeating usage behavior time. These historical components representing seasonal or cyclical behavior will be used as feature values for the feature vector.

At block 311, the controller or a function invoked by the controller (e.g., an API function for a trained model) generates a feature vector with the retrieved feature values and the repeating usage behavior time. Depending upon training, implementations may use the prediction time (e.g., current time) instead of the determined repeating usage behavior time as one of the feature values. The controller runs the trained model to obtain a channel conditions weighting factor that represents predicted current channel conditions of the cellular circuit (“predicted channel conditions weighting factor”).

At block 313, the controller obtains the most recent network path bandwidth measurement corresponding to the active interface and obtains the most recent location of the edge device. These retrieved values will be used for calculating a predicted bandwidth for the cellular circuit attached to the interface.

At block 315, the controller obtains a historical network path bandwidth measurement corresponding to the active interface and cellular circuit and obtains the historical usage data. Again, these historical components are retrieved to capture the impact of repeating behavior in the bandwidth predictions. Thus, these retrieved values are retrieved based on the repeating usage behavior time.

Add log 317, the controller calculates the predicted bandwidth for the cellular circuit attached to the active interface based on the retrieved values and the predicted channel conditions waiting factor. The controller aggregates the predicted channel conditions weighting factor (pred_cc_wf), historical channel conditions weighting factor (hist_cc_wf), and weighting factors determined from the most recent location (location_wf), historical network path bandwidth measurement (hist_bw_wf), and historical usage data (tput_wf). Similar to the mappings in the tables for radio parameters, the weighting factors for the most recent location, the historical network path bandwidth measurement, and the historical usage data, can be defined in tables that map their values to weighting factors. Weighting factors can be static (infrequently changed) or dynamic/adaptive. To illustrate, weighting factors for hist_bw_wf and tput_wf can be determined with respect to an average of the corresponding parameter. If the retrieved historical network path bandwidth measurement is greater than an average of the maximal and minimal bandwidth measurements over a time interval corresponding to the repeating usage behavior time (avg_bw), then hist_bw_wf can be assigned a value of greater than 1 with incremental additions depending on an extent in defined steps beyond avg_bw. If the retrieved historical network path bandwidth measurement is within a defined margin of variance of avg_bw, then hist_bw_wf can be set to 1. If the retrieved historical network path bandwidth measurement is less than avg_bw, then hist_bw_wf is set to a value less than 1, the extent to which can vary similar to when it is above but in a decreasing manner. The tput_wf can be determined in a manner similar to hist_bw_wf. Specific weighting factors and decisions on how to assign them to most recent location, the historical network path bandwidth measurement, and the historical usage data can vary by tenant based on expertise or knowledge that may be specific to the tenant. The controller modifies the most recent network path bandwidth measurement (recent_bw) with the aggregation to calculate the predicted bandwidth (pred_bw):

pred_bw=recent_bw*AVERAGE (pred_cc_wf, hist_cc_wf, location_wf, hist_bw_wf, tput_wf).

At block 319, the controller communicates the bandwidth prediction. The controller can communicate the bandwidth prediction to a destination that will be read by the relevant edge device or communicate directly to the edge device. The prediction can also be saved for model evaluation.

At block 321, the controller determines whether there is another edge device with an active interface with the cellular circuit attached. If so, then operational flow returns to block 305. Otherwise, the operations of FIG. 3 end.

While embodiments could have a local paradigm instead of a centralized paradigm suggested by the examples, there are some additional considerations. For instance, hosting a model locally may avoid demand on a single model and communications to that model, but increases local computational demand to maintain a model at each site or within each edge device. In addition, the time series data could be maintained at each site instead of a centralized repository. However, the time series data is likely used for other monitoring and analysis, thus increasing resource demand to store the same data. Moreover, maintaining the time series data at tenant or organization level instead of at each site facilitates analysis for repeating usage patterns with a wider view.

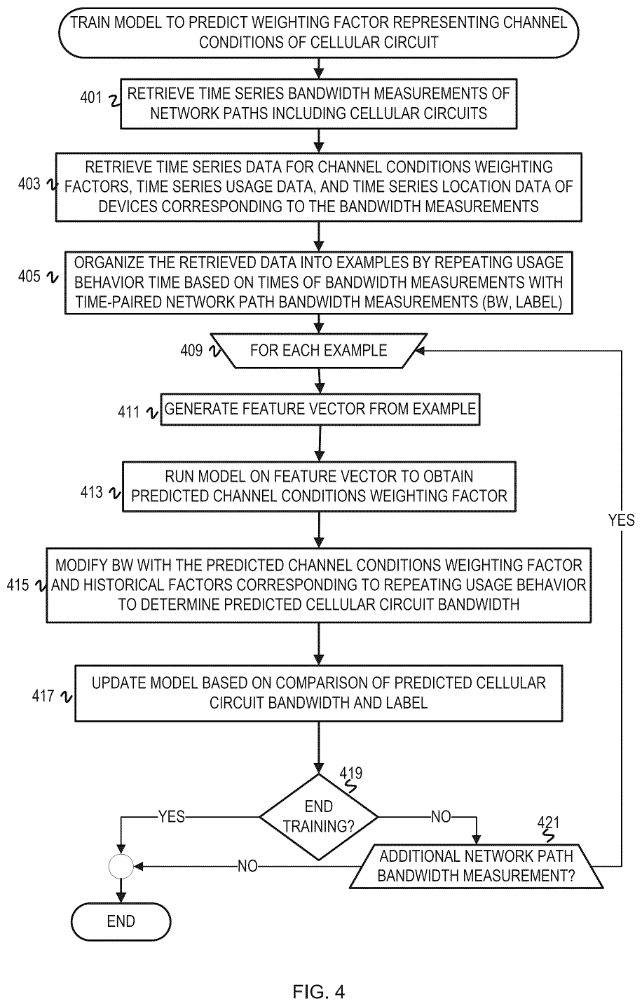

FIG. 4 is a flowchart of example operations for training a model to predict a current channel conditions weighting factor for a cellular circuit. The example operations of FIG. 4 relate to a neural network type of model. Embodiments can use other models, such as a random forest with boosting. Embodiments can train models based on differences between predicted weighting factors and previously computed channel conditions weighting factors as targets/labels or can train models based on accuracy of bandwidths calculated using generated weighting factors with respect to actual bandwidth measurements. FIG. 4 is described with reference to a trainer as performing a model since a trainer refers to the program code for a model, for pre-processing raw training data, and for training the model which usually involves calling defined train or fit functions with the particular features that have been selected through experimentation.

At block 401, the trainer retrieves time series bandwidth measurements of network paths including cellular circuits. These measurements can be accumulated over time to build up the training data set and periodically augmented.

At block 403, the trainer retrieves time series data for channel conditions weighting factors, time series usage data, and time series location data of devices corresponding to the bandwidth measurements. After initial deployment, previously computed channel conditions weighting factors can be used in a training dataset. Initially, the radio parameters used for computing channel conditions will be retrieved and the weighting factors computed therefrom. This retrieved data will be based on the devices and cellular circuits associated with the retrieved bandwidth measurements so they can be correlated. The retrieval of the time series data for channel conditions weighting factors, time series usage data, and time series location data will be retrieved with the query or request indicating the cellular circuits and edge devices corresponding to the retrieved bandwidth measurements. Thus, correlation of the retrieved data to the bandwidth measurements by devices and cellular circuits may be integrated into the retrieval.

At block 405, the trainer organizes the retrieved and correlated data into examples/observations by repeating usage behavior time based on the bandwidth measurement times with time-paired network path bandwidth measurements at times t_{bw} and t_{bw}+1. The bandwidth measurement obtained by an edge device at t_{bw}+1 is selected as a label to evaluate output of the model for training. The trainer also selects a bandwidth measurement (bw) at t_{bw} obtained by the edge device for the same cellular circuit that most recently precedes the label. Assuming the retrieved data are components for computing channel conditions, the trainer computes a channel conditions weighting factor from the values of radio parameters collected for an edge device at a time tr (time of collecting radio parameters data) most recently preceding a time t_{bw} of the network path bandwidth measurement bw. The trainer then computes another channel conditions weighting factor, but with the values corresponding to a time t_{bw}−x that corresponds to the repeating usage behavior time of the network path bandwidth measurement bw. The trainer then selects from the retrieved data the usage data and location based on the repeating usage behavior time. The trainer organizes these values and the repeating behavior time into an example in association with the label.

At block 409, the trainer begins training the model with the examples and labels. In FIG. 4, the trainer iterates through the examples to train the model. The training continues until a termination criterion is satisfied.

At block 411, the trainer generates a feature vector from the values in the example. The feature values include the aforementioned most recent and historical channel conditions weighting factors, the repeating behavior time, the location, and the historical throughput. Preprocessing may normalize this data.

At block 413, the trainer runs the model on the generated feature vector to obtain a predicted channel conditions weight factor. For instance, the trainer passes the feature vector as an argument in a library defined for API defined function.

At block 415, the trainer modifies the network path bandwidth measurement bw with the predicted channel conditions weighting factor and the other historical factors corresponding to the repeating behavior time. For example, the trainer calculates a product of bw and the aggregation of weighting factors. This modification of bw yields a predicted cellular circuit bandwidth.

At block 417, the trainer updates the model based on a loss function that compares the predicted cellular circuit bandwidth and the label. For instance, a model can be updated, for example according to gradient descent or backpropagation based on the result of the loss function and a training data mean standard of error (MSE).

At block 419, the trainer determines whether a training termination criterion has been satisfied. For instance, the trainer determines whether the training data examples have been exhausted or a performance criterion has been satisfied. If training is to end, then operational flow for FIG. 4 ends. Otherwise, the trainer determines whether there is an additional example for training the model at block 421. If there is another example for training the model, then operational flow returns to block 409. If the training data examples have been exhausted, then operational flow ends for FIG. 4.

### Variations

While the example flowchart for model training relates to a neural network type of model, other models can be used. For instance, a regressor random forest with boosting can be used to predict a current channel conditions weighting factor.

The examples refer to data that is used in determining values that represent channel conditions of a cellular circuit and values used as feature values for predicting a current channel conditions weighting factor. Additional data can be used to inform representing channel conditions depending upon cost and/or availability of the data. For instance, additional values can be used and added for radio technology (e.g., EN-DC mode), additional network traffic data can be used (e.g., interface up and down events), data about signal drops and/or connection drops can be used, and changes in radio technology can be used. Data about the frequency bandwidth configuration (primary cell bandwidth, number of aggregated frequency blocks/component carriers, total aggregated bandwidth) can also be used as a factor in determining a weighting factor that represents channel conditions. Likewise, additional feature values can be used for predicting current channel conditions. Example additional feature values can be based on cellular/mobile operator identifier, base station switches corresponding to the repeating behavior time, and disconnects corresponding to the repeating behavior time.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the data collection operations depicted in blocks 207, 209, 211 can be determined in a different order. Moreover, the edge devices do not necessarily determine the weighting factors. Instead of having parameter to weighting factor mappings distributed across devices, the weighting factors mappings and formula for calculating the aggregated channel conditions weighting factor can be centralized. For instance, a process associated with storing the collected data into a centralized repository can also calculate the channel conditions weighting factors and store them in association with the corresponding radio parameters. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

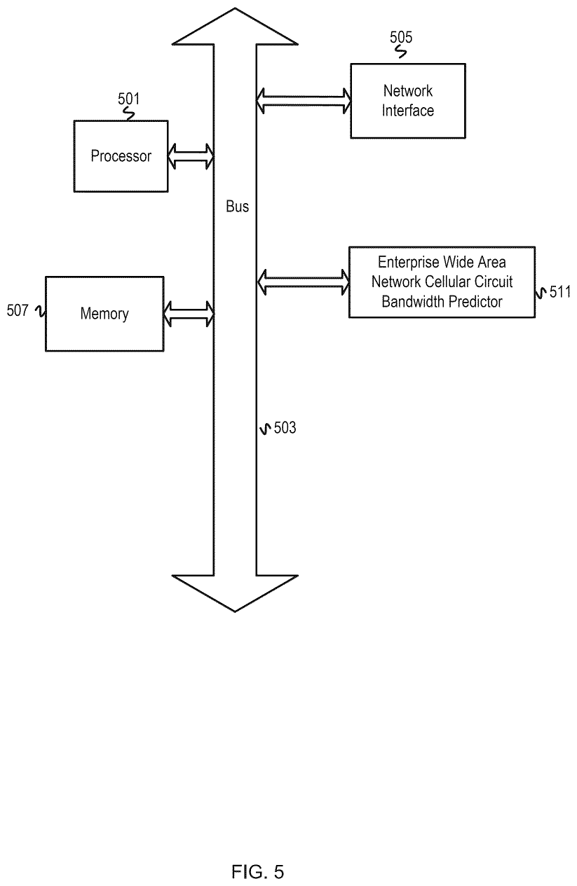

FIG. 5 depicts an example computer system with an enterprise WAN cellular circuit bandwidth predictor. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes an enterprise WAN cellular circuit bandwidth predictor 511. The enterprise WAN cellular circuit bandwidth predictor 511 uses a trained model to determine a weighting factor representative of channel conditions that are current with respect to a time for predicting bandwidth of a cellular circuit. The enterprise WAN cellular circuit bandwidth predictor feeds in data as previously described to obtain the predicted current channel conditions. The enterprise WAN cellular circuit bandwidth predictor 511 may determine the weighting factors that form the input to the model from stored radio parameters if the weighting factors are not already available/previously stored. The enterprise WAN cellular circuit bandwidth predictor 511 then uses the predicted current channel conditions weighting factor to calculate an estimated or predicted cellular circuit bandwidth. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

1. A method comprising:
detecting a trigger for predicting bandwidth of a first cellular circuit attached to a first interface of a first edge device;
determining a first time interval corresponding to a repeating pattern of usage corresponding to the first cellular circuit and location information of the first edge device;
retrieving, from a time series of bandwidth measurements of a network path including the first cellular circuit, a historical bandwidth measurement based on the first time interval and a most recent bandwidth measurement;
retrieving, from a time series of weighting factors that represent channel conditions over time of the first cellular circuit, a first of the weighting factors that represents historical channel conditions based on the first time interval and a second of the weighting factors that represents most recent channel conditions;
retrieving historical usage data corresponding to the first cellular circuit based on the first time interval;
obtaining a predicted weighting factor from submitting to a trained model a first feature vector generated based on the first time interval, the first and the second weighting factors, the location information, and the historical usage data;
predicting bandwidth of the first cellular circuit attached to the first interface of the first edge device based, at least in part, on the most recent bandwidth measurement, the historical bandwidth measurement, the historical usage data, and the predicted weighting factor; and
setting a first bandwidth parameter of the first cellular circuit to the predicted bandwidth.

2. The method of claim 1, wherein predicting bandwidth of the first cellular circuit comprises computing a product of the most recent bandwidth measurement and an aggregation of the historical bandwidth measurement, the predicted weighting factor, and the historical usage data.

3. The method of claim 1, wherein predicting bandwidth of the first cellular circuit comprises computing a product of the most recent bandwidth measurement and an aggregation of the historical bandwidth measurement, the predicted weighting factor, the first weighting factor, a weighting factor based on the location information, and the historical usage data.

4. The method of claim 1, wherein the historical usage data is one of historical usage data of the first cellular circuit attached to the first interface of the first edge device, historical usage data of the first cellular circuit across multiple interfaces of multiple edge devices at a same site as the first edge device, and historical usage data corresponding to the location information.

5. The method of claim 1 further comprising determining a weighting factor that represents channel conditions of the first cellular circuit attached to the first interface of the first edge device, wherein determining the weighting factor is based at least on signal quality metrics, network traffic statistics of the first interface, radio parameters of the first edge device, and antenna gain of the first edge device.

6. The method of claim 1 further comprising maintaining a repository comprising time series of bandwidth measurements of network paths including cellular circuits for a plurality of edge devices and time series of weighting factors that represent channel conditions over time of the cellular circuits associated with the plurality of edge devices.

7. The method of claim 1, wherein the predicted bandwidth is predicted uplink bandwidth, the first bandwidth parameter is an uplink bandwidth parameter, the most recent bandwidth measurement is a most recent uplink bandwidth measurement, the historical bandwidth measurement is a historical uplink bandwidth measurement, and the historical usage data is historical uploaded data.

8. The method of claim 7, wherein the first and second weighting factors represent uplink channel conditions.

9. The method of claim 1, wherein the predicted bandwidth is predicted downlink bandwidth, the first bandwidth parameter is a downlink bandwidth parameter, the most recent bandwidth measurement is a most recent downlink bandwidth measurement, the historical bandwidth measurement is a historical downlink bandwidth measurement, and the historical usage data is historical downloaded data.

10. The method of claim 7, wherein the first and second weighting factors represent downlink channel conditions.

11. The method of claim 1, wherein the trained model has been trained to predict weighting factors for cellular circuit bandwidth prediction with labelled training data, wherein the labels comprise time series weighting factors and raw training data comprise time intervals corresponding to cyclic usage behavior, historical weighting factors correlated with the time intervals, location information of edge devices corresponding to the historical weighting factors, and time series usage data corresponding to the edge devices and correlated with the time intervals.

12. A non-transitory, machine-readable medium having program code stored thereon, the program code comprising instructions to:
determine a first time interval corresponding to a repeating pattern of usage corresponding to a cellular circuit attached to an interface of an edge device;
determine location information of the edge device;
retrieve, from a time series of bandwidth measurements of a network path including the cellular circuit, a historical bandwidth measurement based on the first time interval and a most recent bandwidth measurement;
retrieve, from a time series of values that represent channel conditions of the cellular circuit at different times, a first of the values that represents historical channel conditions based on the first time interval and a second value that represents most recent channel conditions;
retrieve historical usage data corresponding to the cellular circuit based on the first time interval;
submit to a trained model a first feature vector to obtain a predicted channel conditions value, wherein the first feature vector was generated based on the first time interval, the first and the second channel conditions values, the location information, and the historical usage data;
predict bandwidth of the cellular circuit attached to the interface of the edge device based, at least in part, on the most recent bandwidth measurement, the historical bandwidth measurement, the historical usage data, and the predicted channel conditions value; and
set a first bandwidth parameter of the cellular circuit to the predicted bandwidth.

13. The non-transitory, machine-readable medium of claim 12, wherein the instructions to predict bandwidth of the cellular circuit comprise instructions to compute a product of the most recent bandwidth measurement and an aggregation of the historical bandwidth measurement, the predicted channel conditions value, and the historical usage data.

14. The non-transitory, machine-readable medium of claim 12, wherein the instructions to predict bandwidth of the cellular circuit comprise instructions to compute a product of the most recent bandwidth measurement and an aggregation of the historical bandwidth measurement, the predicted channel conditions value, the first channel conditions value, a weighting factor based on the location information, and the historical usage data.

15. The non-transitory, machine-readable medium of claim 12, wherein the historical usage data is one of historical usage data of the cellular circuit attached to the interface of the edge device, historical usage data of the cellular circuit across multiple interfaces of multiple edge devices at a same site as the edge device, and historical usage data corresponding to the location information.

16. The non-transitory, machine-readable medium of claim 12, wherein the program code further comprises instructions to determine measurements of signal quality metrics, network traffic statistics of the interface, radio parameters of the edge device, and antenna gain of the edge device and instructions to determine a channel conditions value based at least on the measurements of signal quality metrics, network traffic statistics of the interface, radio parameters of the edge device, and antenna gain of the edge device.

17. A system comprising:
a processor;
a network interface; and
a machine-readable medium having instructions stored thereon executable by the processor to cause the system to,
determine a first time interval corresponding to a repeating pattern of usage corresponding to a cellular circuit attached to an interface of an edge device;
determine location information of the edge device;
retrieve, from a time series of bandwidth measurements of a network path including the cellular circuit, a historical bandwidth measurement based on the first time interval and a most recent bandwidth measurement;
retrieve, from a time series of values that represent channel conditions of the cellular circuit at different times, a first of the values that represents historical channel conditions based on the first time interval and a second value that represents most recent channel conditions;
retrieve historical usage data corresponding to the cellular circuit based on the first time interval;
submit to a trained model a first feature vector to obtain a predicted channel conditions value, wherein the first feature vector was generated based on the first time interval, the first and the second channel conditions values, the location information, and the historical usage data;
predict bandwidth of the cellular circuit attached to the interface of the edge device based, at least in part, on the most recent bandwidth measurement, the historical bandwidth measurement, the historical usage data, and the predicted channel conditions value; and
communicate the predicted bandwidth for setting a first bandwidth parameter of the cellular circuit.

18. The system of claim 17, wherein the instructions to predict bandwidth of the cellular circuit comprise instructions executable by the processor to cause the system to compute a product of the most recent bandwidth measurement and an aggregation of the historical bandwidth measurement, the predicted channel conditions value, and the historical usage data.

19. The system of claim 17, wherein the instructions to predict bandwidth of the cellular circuit comprise instructions executable by the processor to cause the system to compute a product of the most recent bandwidth measurement and an aggregation of the historical bandwidth measurement, the predicted channel conditions value, the first channel conditions value, a weighting factor based on the location information, and the historical usage data.

20. The system of claim 17 comprising a controller that includes the processor, the network interface, and the machine-readable medium and further comprising the edge device, wherein the edge device comprises a second processor and a second machine-readable medium having stored thereon instructions executable by the second processor to cause the edge device to determine measurements of signal quality metrics, network traffic statistics of the interface, radio parameters of the edge device, and antenna gain of the edge device and instructions executable by the second processor to cause the edge device to determine a channel conditions value based at least on the measurements of signal quality metrics, network traffic statistics of the interface, radio parameters of the edge device, and antenna gain of the edge device.
